(19) United States
(12) Patent Application Publication
(10) Pub. No.: US 2010/0238529 A1
(43) Pub. Date: Sep. 23, 2010

(54) DITHERED HOLOGRAPHIC FRONTLIGHT

(75) Inventors: JEFFREY BRIAN SAMPSELL, Pueblo West, CO (US); MAREK MIENKO, San Jose, CA (US)

Correspondence Address: Weaver Austin Villeneuve & Sampson LLP - QUAL, P.O. Box 70250, Oakland, CA, 94612-0250, US

(73) Assignee: Qualcomm MEMS Technologies, Inc.

(21) Appl. No.: 12/409,289

(22) Filed: Mar. 23, 2009

(51) Int. Cl. G02B 5/32; G03H 1/26; G03H 1/30; F21V 8/00

(52) U.S. Cl. 359/15; 359/22; 359/25; 362/608

(57) ABSTRACT

A reflective or transmissive hologram may be used to extract light from a waveguide. The hologram may be formed by separately exposing each of a plurality of areas of a holographic medium with object beams and/or reference beams having attributes (e.g., illumination angles) that vary randomly or pseudorandomly over the entire hologram. The areas may be contiguous (e.g., in a tiled pattern) or overlapping. In some embodiments, the spacing and/or orientation of the diffraction gratings may vary from area to area. For example, the spacing and/or orientation of the diffraction gratings may vary randomly or pseudorandomly from area to area. Some parts of the hologram may intentionally be made relatively more or relatively less efficient at extracting light from the waveguide.

### FIELD OF THE INVENTION

This application relates generally to display technology and more specifically to the illumination of displays.

### BACKGROUND OF THE INVENTION

There are various devices for display illumination. Some “frontlight” display illumination devices provide light to a waveguide and extract light out of the plane of the waveguide to illuminate a display that is substantially parallel to the waveguide. Various light-extracting elements may be used to extract the light out of the plane of the waveguide, such as prismatic films, holograms, etc. However, illuminating the display uniformly and without creating artifacts has proven to be challenging. Therefore, it would be desirable to provide improved frontlight illumination devices.

### SUMMARY

Improved methods and devices are provided for display illumination. Some such devices use a reflective or transmissive hologram to extract light from a waveguide at angles that are nearly normal to the surface of the waveguide. Such light may, for example, be used to illuminate a microelectromechanical systems (MEMS) device, such as an interferometric modulator (IMOD). The hologram may be formed by separately exposing each of a plurality of areas of a holographic recording medium (also referred to herein as a “holographic recording material” or the like) with object beams and/or reference beams having attributes (e.g., illumination angles) that vary randomly or pseudorandomly over at least part of the hologram. The areas may be contiguous (e.g., in a tiled pattern), may be overlapping and/or may be separated by spaces having no diffraction grating. In some embodiments, the spacing and/or orientation of the diffraction gratings may vary from area to area. For example, the spacing and/or orientation of the diffraction gratings, as well as area attributes (area sizes, area overlaps, etc.), may vary randomly or pseudorandomly over at least part of the hologram.

As used herein, the terms “pseudorandom,” “pseudorandomly,” and the like are used broadly to include processes and distributions that may appear to be random but are not. A pseudorandom distribution may exhibit at least some degree of statistical randomness while being generated by an entirely deterministic process. For example, beam attributes, area attributes, etc., may vary as calculated by a random number generator (RNG) or a pseudorandom number generator (PRNG), but may nonetheless be constrained within limiting ranges.

In order to provide a more uniform illumination of a display, some parts of the hologram may be made relatively more or relatively less efficient at extracting light from the waveguide. For example, low efficiency light extraction areas of the holographic recording material may be formed in parts of the hologram that are relatively closer to a light source, thereby allowing additional light to be available farther from the light source. In some implementations, “unfocused” diffraction gratings may be formed in the low efficiency light extraction areas of the holographic recording material.

Various methods of forming a hologram are described herein. Some such methods involve directing at least one reference beam to a holographic recording material and illuminating 1st through M^{th} areas of the holographic recording material with object beams at 1st through N^{th} illumination angles relative to a normal to the surface of the holographic recording material. The illuminating process may involve forming a random or pseudorandom distribution of the 1st through N^{th} illumination angles across the 1st through M^{th} areas of the holographic recording material. Some such methods may involve directing a plurality of reference beams to the holographic recording material.

The method may involve determining low efficiency light extraction areas of the holographic recording material. The illuminating process may involve forming “unfocused” diffraction gratings in the low efficiency light extraction areas of the holographic recording material. The illuminating process may involve forming a random or pseudorandom distribution of diffraction grating spacing across the 1st through M^{th} areas of the holographic recording material. The illuminating process may involve forming a random or pseudorandom distribution of diffraction grating angles across the 1st through M^{th} areas of the holographic recording material, the diffraction grating angles measured from a first axis parallel to a first diffraction grating of a first area to a second axis parallel to a second diffraction grating of an adjacent area.

The 1st through M^{th} areas may be contiguous or non-contiguous areas of the holographic recording material. Alternatively, the 1st through M^{th} areas may be overlapping areas of the holographic recording material.

The 1st through N^{th} illumination angles may vary within a predetermined range, e.g., within a range of minus six to six degrees relative to the normal, within a range of minus twelve to twelve degrees relative to the normal, within a range of minus 25 to 25 degrees relative to the normal, etc. Similarly, each of the plurality of reference beams may be directed within a particular range of angles relative to the normal. For example, each of the plurality of reference beams may be directed within a range of 55 to 75 degrees relative to the normal.

Methods of manufacturing an illumination device are also provided herein. Some such methods may involve forming a substantially planar light guide having a light coupling section and an adjacent light turning section. The light coupling section may be configured to receive light from a light source and to propagate the light through the light guide to the light turning section. The light turning section may be configured to direct light from the light coupling section out of the light guide.

The process of forming the light turning section may involve the following: directing at least one reference beam to a holographic recording material; and illuminating 1st through M^{th} areas of the holographic recording material with object beams at 1st through N^{th} illumination angles relative to a normal to the surface of the holographic recording material. The illuminating process may comprise forming a random or pseudorandom distribution of the 1st through N^{th} illumination angles across the 1st through M^{th} areas of the holographic recording material. The light coupling section may be configured to receive light through a front surface, a back surface or a side surface of the light guide.

The illuminating comprises may involve forming low efficiency light extraction areas of the holographic recording material. The illuminating comprises may involve forming a random or pseudorandom distribution of diffraction grating spacing across the 1st through M^{th} areas of the holographic recording material. The illuminating comprises may further involve forming a random or pseudorandom distribution of diffraction grating angles across the 1st through M^{th} areas of the holographic recording material, the diffraction grating angles measured from a first axis parallel to a first diffraction grating of a first area to a second axis parallel to a second diffraction grating of an adjacent area.

The 1st through M^{th} areas may be contiguous or non-contiguous areas of the holographic recording material. Alternatively, the 1st through M^{th} areas may be overlapping areas of the holographic recording material.

Various devices are provided herein. Some such devices include the following elements: a light guide; at least one light source configured to provide light to the light guide; a display disposed substantially parallel to the light guide; and a hologram configured to extract light from the light guide and provide light to the display. The hologram may include a plurality of areas, each area having a diffraction grating configured to provide light to the display at a predetermined angle. The predetermined angle may be randomly or pseudorandomly distributed over the plurality of areas. The display may comprise a plurality of reflective interferometric modulators. The hologram may be a reflective hologram, a transmissive hologram or a volume phase hologram.

The diffraction grating of each area may have an angular orientation with respect to the diffraction grating of an adjacent area. The angular orientations may be randomly or pseudorandomly distributed over the plurality of areas. The diffraction gratings may or may not be in focus.

For example, the diffraction gratings in selected areas of the hologram may be formed to be less efficient at light extraction than the diffraction gratings in other areas of the hologram. The selected areas of the hologram may, for example, be proximate at least one light source. The selected areas may be selected to provide substantially uniform illumination of the display.

The device may also include the following elements: a processor that is configured to communicate with the display, the processor being configured to process image data; and a memory device that is configured to communicate with the processor. The device may include a driver circuit that is configured to send at least one signal to the display. The device may include an image source module configured to send the image data to the processor. The device may include a controller configured to send at least a portion of the image data to the driver circuit. The image source module may comprise at least one of a receiver, a transceiver or a transmitter.

These and other methods of the invention may be implemented by various types of hardware, software, firmware, etc. For example, some features of the invention may be implemented, at least in part, by computer programs embodied in machine-readable media. The computer programs may, for example, include instructions for exposing each of a plurality of areas of holographic recording material with object beams and/or reference beams having orientations that vary randomly or pseudorandomly over the entire hologram.

### BRIEF DESCRIPTION OF THE DRAWINGS

FIG. 1 depicts a simplified version of a display device that may include a dithered holographic frontlight as provided herein.

FIG. 2 is a block diagram that illustrates some examples of components of the display device of FIG. 1.

FIG. 3 provides an example of a frontlight for a display, the frontlight having a light source that is coupled to an edge of a light guide.

FIG. 4 provides another example of a frontlight for a display, the frontlight having a light source that is coupled to a bottom side of a light guide.

FIG. 5 provides another example of a frontlight for a display, the frontlight having a light source that is coupled to a top side of a light guide.

FIG. 6 illustrates a process of making multiple exposures of substantially the entire area of a holographic medium.

FIG. 7 illustrates a process of separately exposing each of a plurality of areas of a holographic recording medium.

FIG. 8 illustrates examples of angular relationships between an object beam, a reference beam and a normal to the surface of a holographic medium.

FIG. 9 illustrates examples of angular relationships between an object beam, a reference beam and a line along a surface of a holographic medium.

FIG. 10A is a flow chart that outlines steps of the process illustrated in FIG. 7, according to some implementations provided herein.

FIG. 10B depicts some elements of a system for producing holograms according to some implementations described herein.

FIG. 10C illustrates more details in one example of a system such as that of FIG. 10B.

FIG. 10D is a block diagram that depicts elements of an automated system for producing holograms according to some implementations described herein.

FIG. 11 illustrates a hologram comprising areas having different diffraction grating orientations and/or spacing.

FIG. 12 is a flow chart that outlines steps of a process for making some parts of a hologram relatively more efficient and other parts of a hologram relatively less efficient at extracting light from a waveguide.

### DETAILED DESCRIPTION

While the present invention will be described with reference to a few specific embodiments, the description and specific embodiments are merely illustrative of the invention and are not to be construed as limiting the invention. Various modifications can be made to the described embodiments without departing from the true spirit and scope of the invention as defined by the appended claims. For example, the steps of methods shown and described herein are not necessarily performed in the order indicated. It should also be understood that the methods of the invention may include more or fewer steps than are indicated. In some implementations, steps described herein as separate steps may be combined. Conversely, what may be described herein as a single step may be implemented in multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

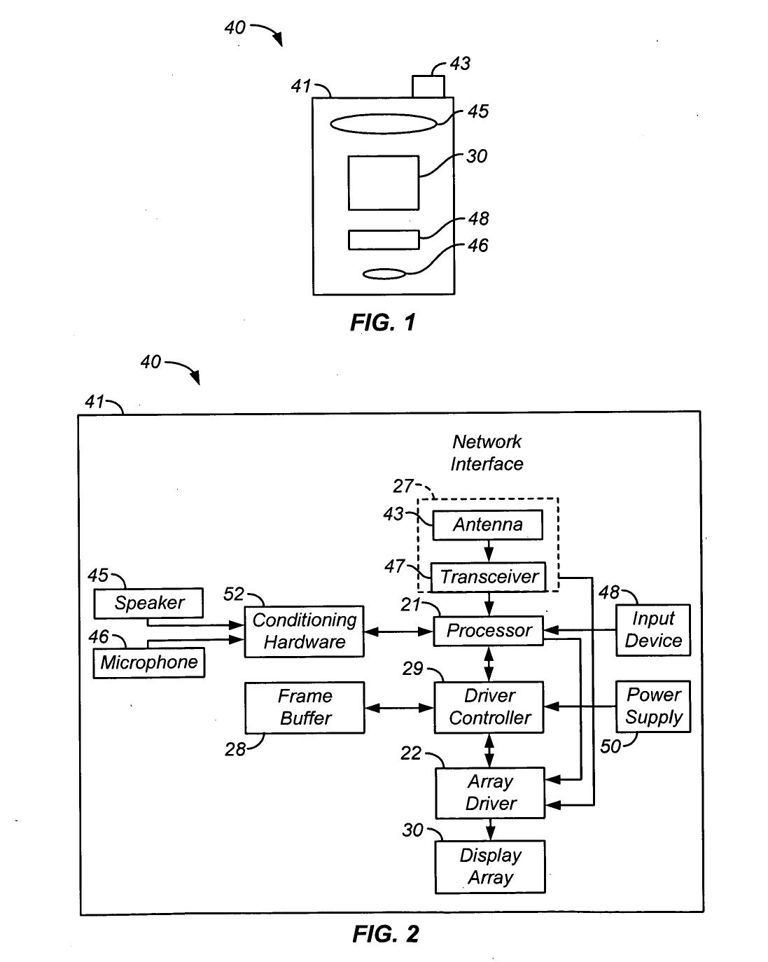

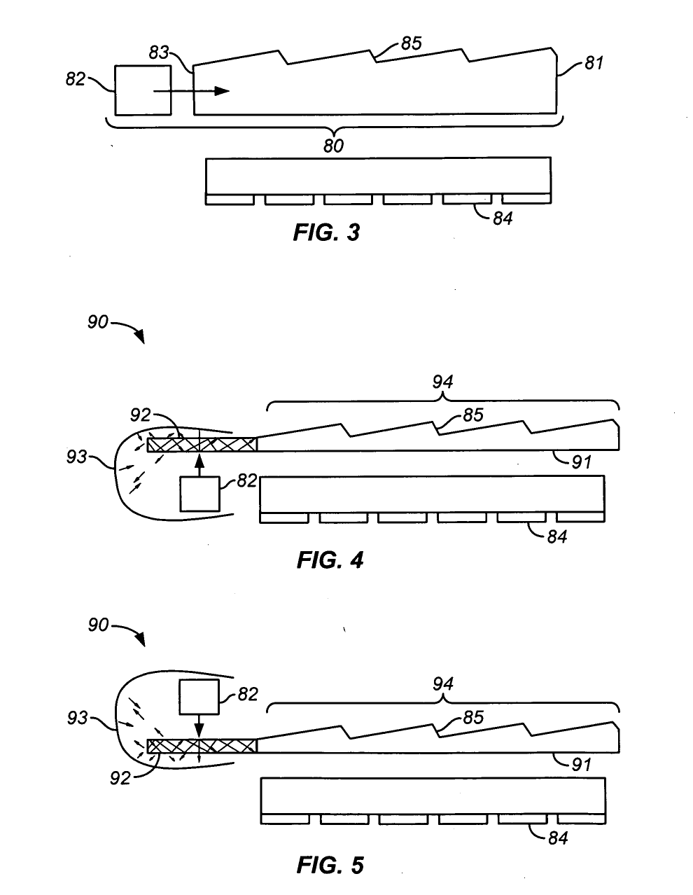

FIGS. 1 and 2 are system block diagrams illustrating an embodiment of a display device 40. The display device 40 can be, for example, a portable device such as a cellular or mobile telephone. However, the same components of display device 40 or slight variations thereof are also illustrative of various types of display devices such as televisions and portable media players.

This example of display device 40 includes a housing 41, a display 30, an antenna 43, a speaker 45, an input system 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 in this example of the display device 40 may be any of a variety of displays. For example, the display 30 may comprise a flat-panel display, such as plasma, electroluminescent (EL), light-emitting diode (LED) (e.g., organic light-emitting diode (OLED)), liquid crystal display (LCD), a bi-stable display, etc. Alternatively, display 30 may comprise a non-flat-panel display, such as a cathode ray tube (CRT) or other tube device, as is well known to those of skill in the art.

However, for purposes of describing the present embodiment, the display 30 includes an interferometric modulator, which may also be referred to herein as an interferometric light modulator or an “IMOD.” An interferometric modulator may be configured to absorb and/or reflect light selectively using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. The position of one plate in relation to another can change the optical interference of light incident on the interferometric modulator. Examples of interferometric modulators are described in various patents and patent applications, including U.S. Pat. No. 7,483,197, entitled “Photonic MEMS and Structures” and filed on Mar. 28, 2006, which is hereby incorporated by reference.

The components of one embodiment in this example of display device 40 are schematically illustrated in FIG. 2. The illustrated display device 40 includes a housing 41 and can include additional components at least partially enclosed therein. For example, in one embodiment, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input system 48 and a driver controller 29. The driver controller 29 is coupled to a frame buffer 28 and to an array driver 22, which in turn is coupled to a display array 30. A power supply 50 provides power to all components as required by the particular display device 40 design.

The network interface 27 includes the antenna 43 and the transceiver 47 so that the display device 40 can communicate with one or more devices over a network. In some embodiments, the network interface 27 may also have some processing capabilities to relieve requirements of the processor 21. The antenna 43 may be any antenna known to those of skill in the art for transmitting and receiving signals. In one embodiment, the antenna is configured to transmit and receive RF signals according to an Institute of Electrical and Electronics Engineers (IEEE) 802.11 standard, e.g., IEEE 802.11(a), (b), or (g). In another embodiment, the antenna is configured to transmit and receive RF signals according to the BLUETOOTH standard. In the case of a cellular telephone, the antenna may be designed to receive CDMA, GSM, AMPS, or other known signals that are used to communicate within a wireless cell phone network. The transceiver 47 may pre-process the signals received from the antenna 43 so that the signals may be received by, and further manipulated by, the processor 21. The transceiver 47 may also process signals received from the processor 21 so that the signals may be transmitted from the display device 40 via the antenna 43.

In an alternative embodiment, the transceiver 47 may be replaced by a receiver and/or a transmitter. In yet another alternative embodiment, network interface 27 may be replaced by an image source, which may store and/or generate image data to be sent to the processor 21. For example, the image source may be a digital video disk (DVD) or a hard disk drive that contains image data, or a software module that generates image data. Such an image source, transceiver 47, a transmitter and/or a receiver may be referred to as an “image source module” or the like.

Processor 21 may be configured to control the overall operation of the display device 40. The processor 21 may receive data, such as compressed image data from the network interface 27 or an image source, and process the data into raw image data or into a format that is readily processed into raw image data. The processor 21 may then send the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 may include a microcontroller, CPU, or logic unit to control operation of the display device 40. Conditioning hardware 52 generally includes amplifiers and filters for transmitting signals to the speaker 45, and for receiving signals from the microphone 46. Conditioning hardware 52 may be discrete components within the display device 40, or may be incorporated within the processor 21 or other components. Processor 21, driver controller 29, conditioning hardware 52 and other components that may be involved with data processing may sometimes be referred to herein as parts of a “logic system” or the like.

The driver controller 29 may be configured to take the raw image data generated by the processor 21 directly from the processor 21 and/or from the frame buffer 28 and reformat the raw image data appropriately for high speed transmission to the array driver 22. Specifically, the driver controller 29 may be configured to reformat the raw image data into a data flow having a raster-like format, such that it has a time order suitable for scanning across the display array 30. Then the driver controller 29 may send the formatted information to the array driver 22. Although a driver controller 29, such as a LCD controller, is often associated with the system processor 21 as a stand-alone Integrated Circuit (IC), such controllers may be implemented in many ways. For example, they may be embedded in the processor 21 as hardware, embedded in the processor 21 as software, or fully integrated in hardware with the array driver 22. An array driver 22 that is implemented in some type of circuit may be referred to herein as a “driver circuit” or the like.

The array driver 22 may be configured to receive the formatted information from the driver controller 29 and reformat the video data into a parallel set of waveforms that are applied many times per second to the plurality of leads coming from the display's x-y matrix of pixels. These leads may number in the hundreds, the thousands or more, according to the embodiment.

In some embodiments, the driver controller 29, array driver 22, and display array 30 may be appropriate for any of the types of displays described herein. For example, in one embodiment, driver controller 29 may be a conventional display controller or a bi-stable display controller (e.g., an interferometric modulator controller). In another embodiment, array driver 22 may be a conventional driver or a bi-stable display driver (e.g., an interferometric modulator display). In some embodiments, a driver controller 29 may be integrated with the array driver 22. Such embodiments may be appropriate for highly integrated systems such as cellular phones, watches, and other devices having small area displays. In yet another embodiment, display array 30 may comprise a display array such as a bi-stable display array (e.g., a display including an array of interferometric modulators).

The input system 48 allows a user to control the operation of the display device 40. In some embodiments, input system 48 includes a keypad, such as a QWERTY keyboard or a telephone keypad, a button, a switch, a touch-sensitive screen, or a pressure- or heat-sensitive membrane. In one embodiment, the microphone 46 may comprise at least part of an input system for the display device 40. When the microphone 46 is used to input data to the device, voice commands may be provided by a user for controlling operations of the display device 40.

Power supply 50 can include a variety of energy storage devices. For example, in some embodiments, power supply 50 may comprise a rechargeable battery, such as a nickel-cadmium battery or a lithium ion battery. In another embodiment, power supply 50 may comprise a renewable energy source, a capacitor, or a solar cell such as a plastic solar cell or solar-cell paint. In some embodiments, power supply 50 may be configured to receive power from a wall outlet.

In some embodiments, control programmability resides, as described above, in a driver controller which can be located in several places in the electronic display system. In some embodiments, control programmability resides in the array driver 22.

Interferometric modulators can be configured into many types of reflective displays that use ambient light to convey information from the display. In conditions of low ambient light, an illumination apparatus can be used to illuminate a reflective interferometric modulator display or another type of display.

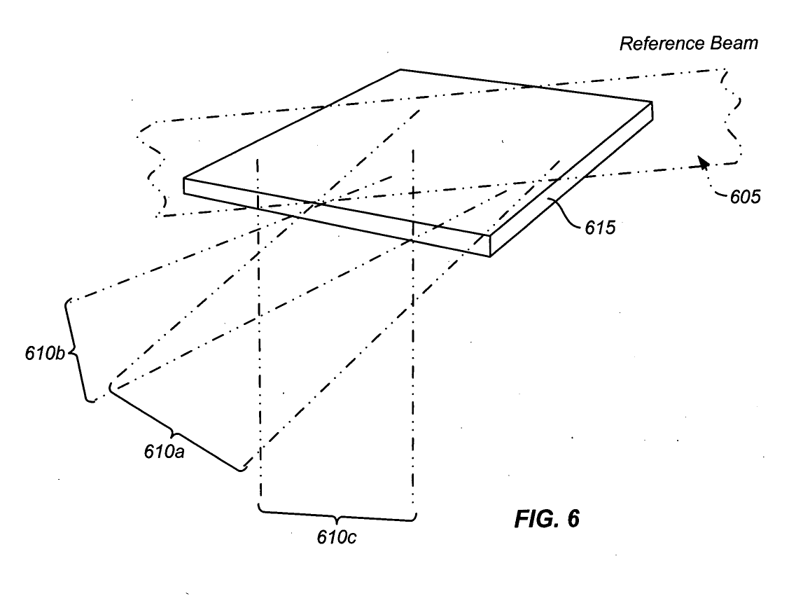

For example, FIG. 3 illustrates one embodiment of a front illumination device 80 (also referred to herein as a “frontlight” or the like) that can be used to illuminate a reflective interferometric modulator display 84 or another type of display. The front illumination device 80 can include a light source 82 and a front illuminator 81, a light guide comprising, e.g., one or more film, film stack, sheet, and/or slab-like components. Front illuminator 81 may include turning features 85 that direct light propagating in the light guide onto the interferometric modulator display 84.

Although turning features 85 are depicted as prismatic features in FIGS. 3-5, in various embodiments described herein turning features 85 comprise holographic elements. Examples of such holographic elements are described in more detail below. Moreover, although turning features 85 are depicted in FIGS. 3-5 as being on the distal side of front illuminator 81, relative to display 84, in alternative embodiments turning features 85 may be formed on the proximal side of front illuminator 81, relative to display 84.

Accordingly, for implementations wherein turning features 85 comprise holographic elements, the holographic elements may be reflective, transmissive or volume holographic elements. Turning features 85 that comprise reflective holographic elements would generally be formed on the distal side of front illuminator 81, whereas turning features 85 that comprise transmissive holographic elements would generally be formed on the proximal side of front illuminator 81. In some such implementations, holographic turning features 85 may be laminated to the distal or the proximal side of front illuminator 81. In alternative implementations wherein holographic turning features 85 comprise volume holographic elements, holographic turning features 85 may be formed within front illuminator 81.

In some implementations, front illuminator 81 may comprise the “front glass” of a display, through which a viewer views the display. The front glass may or may not actually be formed of glass, but could instead be formed of any suitable transparent material, e.g., of polycarbonate. In some such implementations, holographic turning features 85 may be laminated to the distal or the proximal side of the front glass. In some such implementations, additional layers may be laminated to the front glass, e.g., to improve its performance as a waveguide. For example, in some implementations, one or more thin film layers having a lower index of refraction than that of the front glass may be formed on the front glass.

The light source 82 may be coupled to an edge 83 of the light guide 81 (“edge-coupled”) to provide light to interferometric modulators configured in a reflective display 84. A portion of light emitted by the light source 82 enters the edge 83 of the light guide 81 and propagates throughout the light guide 81 utilizing the phenomenon of total internal reflection. As described above, the light guide 81 can include turning features 85 that re-direct a portion of the light propagating through the film towards the display 84. In this example, the front illuminator/light guide 81 is relatively thick, to provide a large enough edge 83 to receive and couple light from the light source 82. Accordingly, this configuration causes the illumination device 80 be relatively thick, in order to accommodate the light guide 81.

Market forces dictate providing increasingly thinner display modules. Reducing the thickness of an edge-coupled front illumination device 80 may require reducing the thickness of the light source 82: while the front illuminator/light guide 81 can be made thinner, there may be practical limitations to how thin light sources can be made. In one example, a LED has a thickness of 0.2-0.3 mm, and the LED package further adds to this thickness. For edge-coupled embodiments, reducing the thickness of the light guide 81 beyond that of the light source 82 leads to inefficient optical coupling of the light source to the light guide because not all the emitted light can be delivered into the light guide 81. This is due to the physical size mismatch between the emitting aperture of the light source 82 and the input aperture (edge surface 83) of the light guide 81 in such configurations. Accordingly, for edge-coupled embodiments, reducing the thickness of a light guide 81 involves a tradeoff between having a suitably a thin light guide, e.g., a thin film or film stack, and having light injection efficiency.

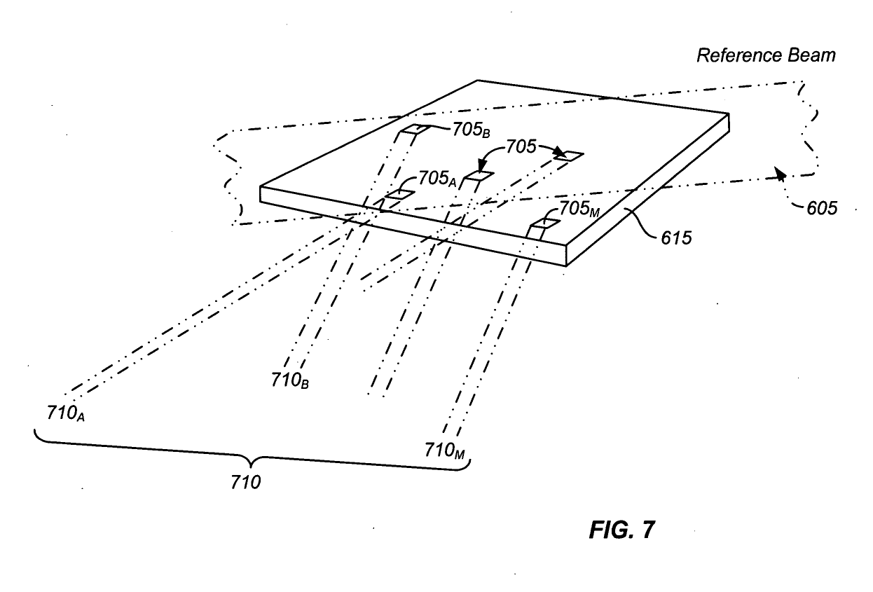

FIG. 4 illustrates an example of an illumination device with both a surface coupling section and a light turning section that overcomes the above-discussed problems of edge-coupled embodiments. The embodiment can include light coupling of various means (specific illustrations of which are described below) to couple a light source through the surface of a front illumination device that propagates the light to a reflective interferometric modulator display (or another type of reflective display). The embodiment of FIG. 4 includes a front illumination device 90 having a light guide 91 placed “above” an interferometric modulator display 84 so that the light guide 91 is between the interferometric display 84 and ambient light illuminating the display. The light guide 91 may be a substantially planar structure that may comprise one or more films, film stacks, sheets, or slab-like components. Although the light guide is described herein as substantially “planar,” the light guide, or portions of the light guide, may have surface features for reflecting light, diffracting light, refracting light, scattering light and/or providing light using light emitting materials, such that the light guide surface may or may not be smooth.

In this example, the front illumination device 90 includes a light turning section 94 which comprises a portion of the light guide 91. The light turning section 94 may also be referred to herein as the “illumination section” or “illumination region” which operates to illuminate or distribute light across the reflective display 84. The light turning section 94 has a “front” surface facing outward towards any ambient light, and a “back” surface facing inwards towards the reflective display 84.

The light turning section 94 may include one or more light turning features 85. The light turning features 85 illustrated in FIG. 4 comprise prismatic features. However, in other embodiments, other reflective, diffractive (including surface and volume holographic diffraction gratings) and/or other types of light-redirection structures can be used. Light turning features 85 can be configured having consistent or varied spacing and/or periodicity, and be of different relative size and shape than those illustrated in FIG. 4. Moreover, the elements depicted in FIG. 4, as with the other figures presented herein, are not necessarily drawn to scale. For example, for a device of the overall size depicted in FIG. 4, light turning features 85 would generally not be visible to the unaided eye. Light turning features in the light turning section 94 can be disposed on or near the front or back surface of the light turning guide 94 (e.g., disposed inside the light turning section 94 near the surface). The light turning section 94 may be positioned over the display 84 such that the light turning features 85 can direct light to interferometric modulator pixels in the display 84.

The illumination device 90 also includes a light coupler section 92 and a light source 82. The light coupler section 92 comprises a portion of the light guide 91 which receives optical energy (generally referred to herein as “light”) from the light source 82. In some examples described herein, the emission from a light source may be in the visible spectrum and in other cases it may be in the non-visible spectrum (e.g., ultraviolet (UV)). Accordingly, references to a light source emission (e.g., “optical energy” or “light”) are not intended to be limited to those within the visible spectrum. The light source 82 may be positioned to provide light into the light coupler section 92. Specifically, the configuration and/or position of the light source 82, and the configuration of the light coupler section 92, allows light to enter a surface of the light guide 91 in the light coupler section 92. In this example, the surface that allows light to enter is a surface other than, or in addition to, the edge of the light guide 91.

In some embodiments, the surface of the light guide 91 that receives the emitted light is the surface proximal to the display 84, as shown in FIG. 4. In some embodiments, a light source 82 is positioned to emit light to a surface of the light guide 91 distal from the display 84. As used herein, the proximal surface of the light guide 91 refers to the back surface that is adjacent to the display 84, and the distal surface refers to the surface of the light guide 91 that is positioned away from the display 84, that is, the surface of the light guide 91 that normally receives ambient light.

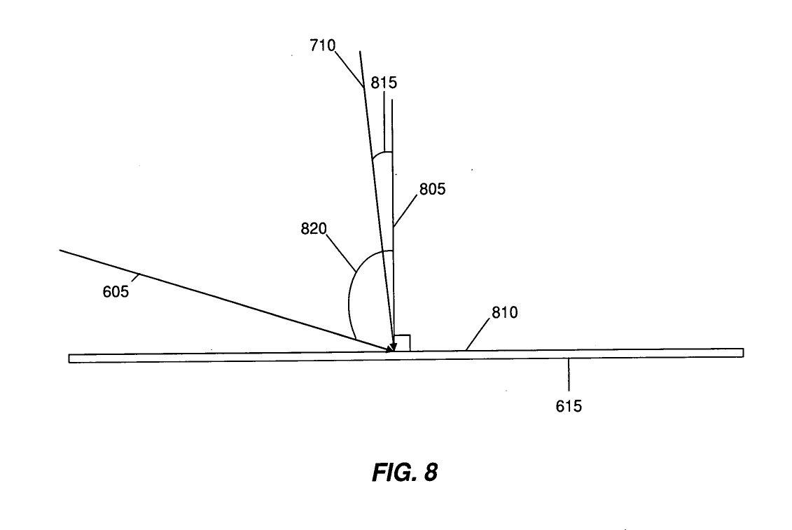

In some embodiments, the light source 82 may be disposed on the opposite side of the light coupler section 92, e.g., as illustrated in FIG. 5. However, such an embodiment may result in a thicker display. In certain embodiments (for example as illustrated in FIG. 4) the surface which receives the light from the light source 82 is (substantially) parallel to the display 84 and is located outside of the display 84 viewing area. The light coupler section 92 can include a variety of coupling means to receive light from the light source 82 and direct the light to propagate into the light turning section 94 of the illuminator 91. Light entering the light guide 91 can be diffracted, reflected, scattered, and/or absorbed and re-emitted by optical features, surface volume structures and/or structured coatings incorporated within the coupler region 92 of the light guide 91. Such features, surface volume structures and structural coatings can be disposed inside, or on a surface of, the light coupler section 92. At least some of the coupled light propagates throughout the light guide 91 through total internal reflection. As light propagates through the light guide 91, a portion of the light reflects off of one or more of the light turning features 85 in the light guide 91 and propagates to a display 84. The display 84 can comprise interferometric display elements, which reflect or absorb the light depending on their interferometric state.

The light source 82 can comprise one or more light emitting elements, for example, an LED, a light bar, and/or a cold cathode florescent lamp (CCFL). In some embodiments, a single LED is used while in other embodiments a plurality of LED's (e.g., five or more) may be used. In some embodiments, the light source 82 emits light directly into the light coupler section 92. In some embodiments, the light source 82 includes a light emitting element and a light spreading element (e.g., a light bar) which receives the light from one or more light emitting elements, (e.g., LED's). In some such embodiments, the light emitting elements are effectively point sources but the light source 82 provides the light to the light coupler section 92 substantially as a line source. Some such line source “light bars” may comprise an OLED fashioned to be as long as the frontlight is wide.

The light may then be received by light coupler section 92 and transmitted through the light guide 91. Accordingly, the light may be transformed from a line source into a distributed area source so as to provide sufficiently uniform illumination across the display 84. Using a single light emitting element can lower power consumption. In other embodiments, a plurality of colored LEDs may be used in the light source 82 and combined to form white light. A light spreading element can include diffusing material (e.g., a volume diffuser containing particles, pigments, etc.) and light directing structures that facilitate transforming a received point source light, or numerous point sources, into a line light source. In some embodiments, the light coupler section 92 contains diffusing material and light directing structures so that light from the light source interacts with the diffusing material and light structures before the light enters the light guide 91.

Some embodiments include a reflector 93 positioned partially around the light coupler section 92 and the light source 82. Shown from an end view in FIG. 4, the reflector 93 may be configured, e.g., as a U-shaped or rectangular-shaped structure. The reflector 93 can be positioned along a portion or the entire length of a light source 82 which in this example extends along one edge of the display in the light coupler section 92. In some embodiments, the far end of the reflector 93 is closed to reflect light emitted from the coupler section 92 back into the light coupler section 92. The reflector can be placed in various locations and proximities with respect to the light coupler section 92 and the light source 82, according to the implementation. In some embodiments, the reflector closely conforms to the surface of the light coupler section 92 and the light source 82. The reflector 93 can comprise suitable reflective metallic material, for example, aluminum or silver, or the reflector 93 can comprise nonmetallic reflective material, films, or structures.

The reflector 93 can increase the coupling efficiency by redirecting light propagating out of the light coupler section 92 back into the light coupler section 92 for further interaction with the coupling microstructure. In one example, light from the light source 82 enters the light coupler section 92 and propagates to a diffraction grating disposed in, or adjacent to, the light coupler section 92. Some of the light is diffracted to the right (towards the display 84), and some of the light is diffracted to the left towards the reflector 93 as illustrated in FIG. 4. A certain portion of light may travel through and exit the light coupler section 92. Light diffracted to the left in FIG. 4 (away from the display) may be reflected internally within the light guide 91 and remain therein, but some light may exit the light guide 91. The reflector 93 can be positioned to reflect at least some of the light emitted from the light coupler section back towards the light coupler section 92, such that the light re-enters the light guide 91 and propagates towards the display 84. The reflector 93 can be shaped to maximize the amount of light reflected back towards the light guide 91. For example, the reflector 93 can be “U”-shaped or parabolically-shaped. A reflector 93 may be used in any of the embodiments described herein to increase the light coupling efficiency. For example, edge-coupled embodiments such as those depicted in FIG. 3 may also include a reflector 93 positioned partially around the light source 82. In an embodiment, the surface of the reflector 93 is a specular reflector. In another embodiment, the reflector 93 comprises diffusely reflecting surfaces.

Illustrative surface coupling embodiments are described and may include reflective or transmissive surface diffractive gratings, volume diffractive gratings, prismatic devices, light scattering and/or light absorption and re-emission based devices. Such embodiments may be referred to herein as “surface couplers,” because light is coupled primarily through the top or bottom surface of the light guide 91 and not through the edge 83 of the light guide as shown in FIG. 3, or only minimally through the edge 83 in the presence of a reflector as shown in FIGS. 4 and 5. The various illustrative embodiments illustrating coupling a light through the surface of a thin light guide can include using surface diffractive microstructures, surface diffractive reflectors, volume diffractive holographic recordings, prismatic microstructures, light scattering and/or emission-based elements to couple light from a light source 82 to an illuminator light guide 91 to provide a frontlight to a reflective display. In such embodiments, the light coupling section 92 can reside outside the viewable area of the display. The front illuminator light guide 91 can be manufactured such that both a light coupling section 92 and a light turning section 94 are created in the same step, e.g., via embossing a plastic film.

As noted above, in some embodiments turning features 85 comprise holographic elements. Various methods of forming these holographic elements are described herein.

In conventional holography, some of the light scattered from, reflected from, or transmitted by an object or a set of objects is directed to a holographic recording medium. The source of this light is often referred to as an “object beam” or the like. A second light beam, often referred to as a “reference beam,” also illuminates the recording medium, so that interference occurs between light coming from the two beams. The object beam and the reference beam may, for example, be formed from a single beam of coherent light (e.g., laser light) that has been split by a beam splitter. The resulting light field, incident upon the hologram, creates a diffraction pattern (also referred to herein as a diffraction grating) of varying intensity within the holographic material.

A light wave can be mathematically represented by a complex number U, which represents the electric and magnetic fields of the light wave. The amplitude and phase of the light are represented by the absolute value and angle of the complex number. The object and reference waves at any point in the holographic system are given by U_{O} and U_{R}. The combined beam is the sum of U_{O} and U_{R}. The energy of the combined beams is proportional to the square of magnitude of the electric wave:

|U_{O}+U_{R}|²=U_{O}U*_{R}+|U_{R}|²+|U_{O}|²+U*_{O}U_{R}.

If a holographic medium is exposed to the object and reference beams, the transmittance T of the resulting diffraction pattern is proportional to the light energy that was incident on the holographic medium. The transmittance T of the resulting hologram may be represented by the following equation:

T=k[U_{O}U*_{R}+|U_{R}+|U_{R}|²+|U_{O}|²+U*_{O}U_{R}], where k is a constant.

If the hologram is illuminated by the original reference beam, a light field is diffracted by the reference beam which is substantially identical (to the extent allowed by the quality of the holographic medium) to the light field which was scattered by the object or objects. Someone observing the hologram appears to see a three-dimensional representation of the object(s). When the hologram is illuminated by the reference beam, the light transmitted through the hologram, U_{H}, may be represented as follows:

$$\begin{matrix}{U}_{H} = {TU}_{R} \\ = k [ {U}_{O} {U}_{R}^{*} + {\vert {U}_{R} \vert}^{2} + {\vert {U}_{O} \vert}^{2} + {U}_{O}^{*} {U}_{R} ] {U}_{R} \\ = k [ {U}_{O} + {\vert {U}_{R} \vert}^{2} {U}_{R} + {\vert {U}_{O} \vert}^{2} {U}_{R} + {U}_{O}^{*} {U}_{R}^{2} ] .\end{matrix}$$

U_{H} has four terms. The first of these is kU_{O}, which represents the reconstructed object beam. The second term represents the reference beam, the amplitude of which has been modified by U_{R}². The third term also represents the reference beam, which has had its amplitude modified by U_{O}². This modification corresponds to the reference beam being diffracted around its central direction. The fourth term is sometimes referred to as the “conjugate object beam.” The conjugate object beam has an opposite curvature as compared to the object beam itself. The conjugate object beam forms a real image of the object in the space beyond the hologram.

Some methods of forming turning features 85 as holographic elements do not involve directing light to an object to form the object beam. According to some such methods, the “object beam” may be one or more beams of light having a desired orientation for illuminating a display. One may conceive of such methods as being comparable to methods of creating a hologram of a mirror.

Some methods of forming turning features 85 as holographic elements have produced unsatisfactory results. For example, some such methods have caused holographic turning features 85 to produce “rainbow” effects when light source 82 is in use. These rainbow effects are the result of color dispersion.

Some methods of addressing the color dispersion problem involve making multiple grating exposures of different grating spacing over the entire area of the hologram. With each exposure the rainbow effect decreases.

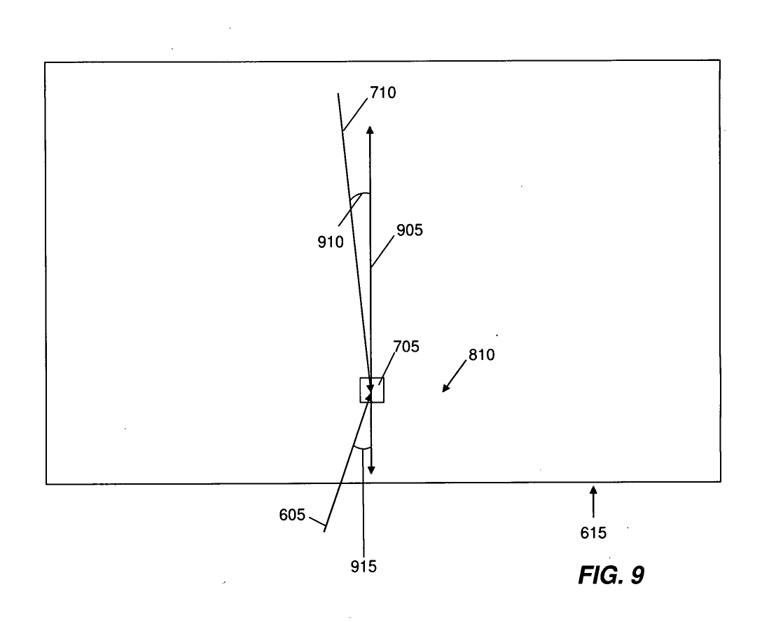

One such method is illustrated in FIG. 6. In this example, reference beam 605 and object beam 610a illuminate substantially all of holographic medium 615, forming a first diffraction pattern in holographic medium 615. Object beam 610a may illuminate holographic medium 615 at approximately a desired angle of illuminating a display with the resulting hologram, e.g., at an angle that is approximately normal to the surface of holographic medium 615. For example, object beam 610a may illuminate holographic medium 615 at an angle that is between one and six degrees from a normal to the surface of holographic medium 615.

Various types of holographic media and light sources may be used. Some examples of suitable materials for holographic medium 615 include dichromated gelatin, photographic emulsions, photopolymers, liquid crystals and bleached photoresists. Suitable light sources include laser light (e.g., laser light that has passed through a beam expander), halogen light sources that emit a small number of tight emission peaks, etc.

Next, reference beam 605 and object beam 610b illuminate substantially all of holographic medium 615 to form a second diffraction pattern. As illustrated in FIG. 6, object beam 610b illuminates holographic medium 615 at a different angle, as compared to object beam 610a. In some implementations, reference beam 605 may also illuminate holographic medium 615 at a different angle when forming subsequent diffraction patterns. More details regarding suitable angles for object beams and reference beams are provided below. Accordingly, the second diffraction pattern formed by object beam 610b and reference beam 605 is somewhat different from the first diffraction pattern formed by object beam 610a and reference beam 605.

A third diffraction pattern is then formed on substantially all of holographic medium 615 by reference beam 605 and object beam 610c. The angle of object beam 610c may, for example, differ from the angles of object beam 610a and object beam 610b by predetermined amounts. Alternatively, or additionally, the angle of object beam 610c may differ from the angles of object beam 610a and object beam 610b by at least threshold amounts, within a predetermined angle range.

Although three diffraction patterns were formed in the above-described process, alternative methods may involve forming more or fewer diffraction patterns. Moreover, while the foregoing process has been described as a sequential process of forming the diffraction patterns, alternative methods involve forming at least two, and sometimes all, of the diffraction patterns simultaneously.

Forming multiple—and slightly different—diffraction patterns on substantially all of holographic medium 615 tends to ameliorate the “rainbow” effect: colors tend to be distributed more uniformly across the display. If a sufficiently large number of such diffraction patterns were formed on substantially the entire holographic medium 615, the rainbow effect would be undetectable to most observers. However, the dynamic range of holographic material used by the inventors thus far has been consumed before enough exposures have been made to eliminate the rainbow effect. Although holographic materials of adequate dynamic range may presently exist or may be developed in the future, alternative methods are provided herein to overcome the dynamic range limitations of some holographic materials.

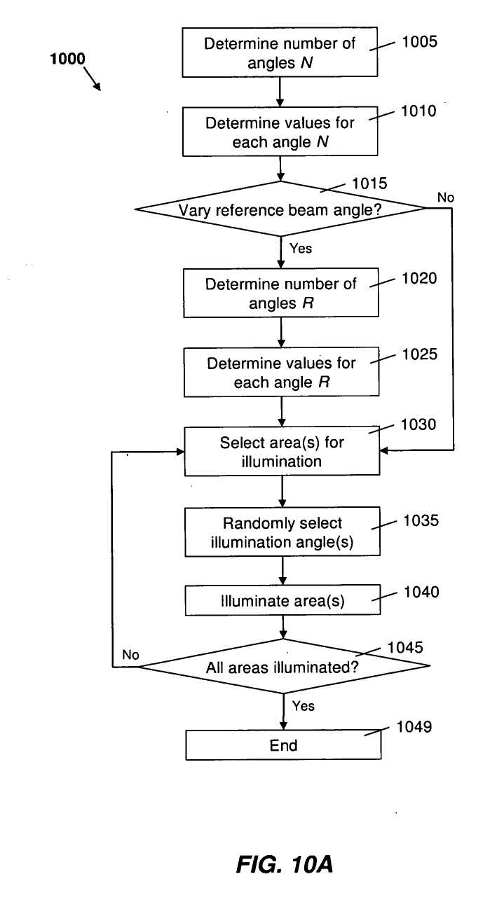

One such method is illustrated by FIG. 7. In this example, a diffraction grating is formed in each of M areas 705 by the interference of reference beam 605 and one of object beams 610. For example, a diffraction grating is formed in area 705_{A} by the interference of reference beam 605 and object beam 710_{A}. Another diffraction grating is formed in area 705_{B} by the interference of reference beam 605 and object beam 710_{B}, and so on, until a diffraction grating is formed in area 705_{M} by the interference of reference beam 605 and object beam 710_{M}. Some implementations involve forming diffraction gratings sequentially in each of the areas 705, whereas other implementations may involve forming diffraction gratings simultaneously in at least some of the areas 705.

Although only a few areas 705 are depicted in FIG. 7, in the present example areas 705 are formed over substantially all of holographic medium 615. The value of M may vary according to the implementation. Accordingly, some implementations may involve forming a diffraction grating in tens of areas 705, others may involve forming a diffraction grating in hundreds of areas 705 and still others may involve forming a diffraction grating in thousands of areas 705. Alternative implementations may involve forming diffraction gratings in more or fewer areas 705.

In some implementations, areas 705 are made to be substantially contiguous, e.g., in a “tiled” pattern. Some examples are described and illustrated elsewhere herein. In alternative implementations, at least some of areas 705 are intentionally made to overlap. In other implementations, more than one diffraction pattern will be made over all, or substantially all, of each area 705. For example, if the dynamic range of the holographic medium is adequate, 2 or 3 different diffraction patterns may be formed in at least some of areas 705. However, in some implementations described below, at least some of areas 705 may not be contiguous or overlapping, but instead may deliberately be separated by spaces having no diffraction pattern.

Some implementations involve forming diffraction patterns in areas 705 according to a random or pseudorandom distribution of object beam attributes and/or reference beam attributes. For example, some implementations involve forming a random or pseudorandom distribution of 1^{st} through N^{th} object beam illumination angles across the 1^{st} through M^{th} areas of the holographic recording material. Other implementations may involve a random or pseudorandom distribution of other object beam attributes, e.g., of object beam polarization angles.

Moreover, in some implementations one or more attributes of reference beam 605 may change. For example, the illumination angle and/or polarization angle of reference beam 605 may change. Although reference beam 605 is depicted in FIG. 7 as illuminating a relatively large area of holographic medium 615, alternative implementations may involve directing reference beam 605 to a smaller portion of holographic medium 615. For example, if areas 705 are exposed sequentially instead of simultaneously, in some implementations reference beam 605 may be directed to the vicinity of each area 705 that is being exposed by an object beam 710. Accordingly, some such methods may involve directing a plurality of reference beams 605 to the holographic recording material, either simultaneously or sequentially.

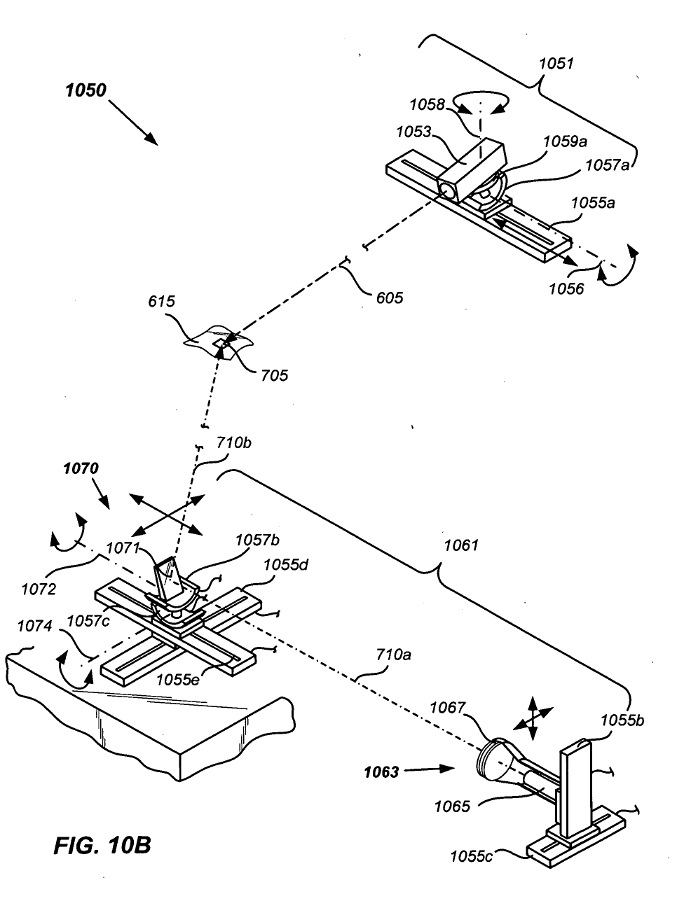

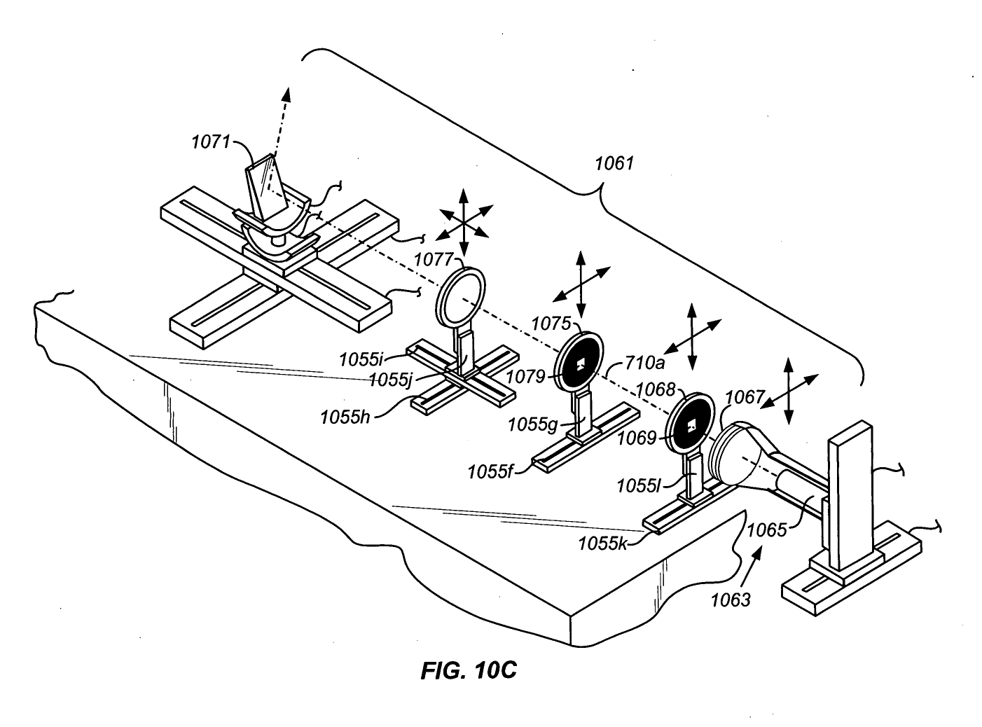

Some examples of angle ranges for object beams 710 and reference beams 605 will now be described with reference to FIGS. 8 and 9. Referring first to FIG. 8, a side view of holographic medium 615 is shown. Normal 805 is perpendicular to surface 810 of holographic medium 615. In some implementations, all (or substantially all) of object beams 710 will be directed to holographic medium 615 within a predetermined angle 815 relative to normal 805. For example, in some implementations all of object beams 710 will be within a range of minus six to six degrees relative to normal 805. In alternative implementations, all of object beams 710 will be within a range of minus twelve to twelve degrees relative to normal 805. In other implementations, all of object beams 710 will be within a range of minus 25 to 25 degrees relative to normal 805.

According to some implementations, all (or substantially all) of reference beams 605 are directed to holographic medium 615 at a predetermined angle 820 relative to normal 805 or within a predetermined range of angles relative to normal 805. For example, in some such implementations, reference beams 605 are directed to holographic medium 615 within a range of 55 to 75 degrees relative to normal 805. However, the foregoing angles and angle ranges for object beams and reference beams are merely made by way of example.

FIG. 9 depicts a top view of holographic medium 615. Axis 905 extends along a top surface 810 of holographic medium 615. Like normal 805 of FIG. 8, axis 905 is not a physical structure. Axis 905 is shown merely to provide a reference from which angular relationships may be illustrated and described. In FIG. 9, object beam 710 and reference beam 605 are shown simultaneously illuminating area 705 of holographic medium 615.

One purpose of FIG. 9 is to show that, in addition to having an angular relationship to a normal to surface 810, object beam 710 and/or reference beam 605 may or may not lie within the plane of axis 905. Here, object beam 710 illuminates area 705 at an angle 910 relative to axis 905 and reference beam 605 illuminates area 705 at an angle 915 relative to axis 905. In some implementations, these angular relationships may be constrained. For example, in some implementations, angle 915 and/or angle 910 may be fixed, whereas angle 815 and/or angle 820 (see FIG. 8) may vary in a random or pseudorandom fashion from one area 705 to another. In alternative implementations, angle 915 and/or angle 910 may be allowed to vary. According to some such implementations, angle 915 and/or angle 910 may also vary in a random or pseudorandom fashion from one area 705 to another. In some implementations, angle 915 and/or angle 910 may only be allowed to vary within a predetermined range. In some implementations, the size and/or degree of overlap of areas 705 may vary in a random or pseudorandom fashion, but the degree of variation may also be constrained within a predetermined range.

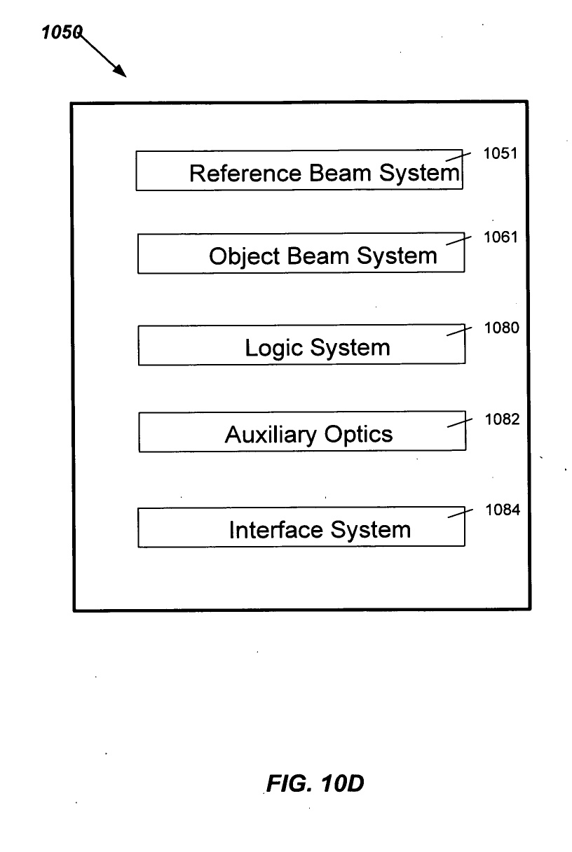

FIG. 10A is a flow chart that outlines steps of preparing a hologram according to some implementations provided herein. Some such holograms may, for example, have properties suitable for extracting light that is propagating in a light guide onto a display, e.g., onto an interferometric modulator display. These holograms are formed by randomly or pseudorandomly varying object beam attributes and/or reference beam attributes when forming diffraction gratings in areas of a holographic medium.

Accordingly, method 1000 starts with a process of determining a number of object beam attributes to be varied randomly or pseudorandomly. In this example, the object beam attributes to be varied include, but are not necessarily limited to, illumination angles of the object beam. The object beam illumination angles may be measured relative to any convenient reference, but in this example the object beam angles are measured with reference to a normal from a surface of a holographic medium. In step 1005, a number N of such angles is determined.

A value for each of the N angles is then determined. (Step 1010.) For example, a value for each of the N angles may be selected from the angle ranges described above. In some implementations, the 1^{st} through N^{th} object beam illumination angles may all be within a range of minus six to six degrees relative to the normal. For example, if N were set to 5 in step 1005, the angles might be −5, −2, 1, 4 and 6 degrees. In other implementations, the 1^{st} through N^{th} object beam illumination angles may all be within a range of minus twelve to twelve degrees relative to the normal. If N were set to 7 in step 1005, the angles might be −11, −7, −3, 1, 5, 9 and 12 degrees. In still other implementations, the 1^{st} through N^{th} object beam illumination angles may all be within a range of minus 25 to 25 degrees relative to the normal. If N were set to 9 in step 1005, the angles might be −24, −18, −12, −6, 1, 7, 13, 19 and 25 degrees. However, the number of angles and the values for these angles are only examples. Although odd values of N are provided in these examples, even values may also be used.

In step 1015, it is determined whether the reference beam illumination angle will also be varied. If so, a number R of reference beam illumination angles may be determined in step 1020. Values for the reference beam illumination angles may be selected in step 1025. For example, each of the R reference beams may have an illumination angle selected from a range of 55 degrees to 75 degrees relative to the normal. If R were determined to be 4 in step 1020, for example, the illumination angles might be 60, 65, 70 and 75 degrees.

In step 1030, one or more areas of a holographic medium are selected for illumination. In some implementations, each area is illuminated in sequence, e.g., each consecutive area of a row, each consecutive area of a column, or in any other convenient manner. In alternative implementations, more than one area may be illuminated at a time. For example, areas of the holographic medium may be illuminated row by row, column by column, or in any other convenient manner.

The object beam and/or reference beam illumination angles are randomly or pseudorandomly selected in step 1035. For example, an RNG or a PRNG may generate a number that corresponds to one of the N object beam illumination angles. In one such implementation, the RNG or PRNG may select a number, e.g., between 1 and 1,000. If N were selected to be 4, for example, 250 of these numbers could correspond to one of the 4 angles, 250 other numbers could correspond to another one of the 4 angles, and so on. If the reference beam angle is also being varied, a similar process may be applied to select one of the R reference beam illumination angles.

In other implementations step 1035 may involve other methods of simulating randomness. For example, other implementations may involve PRNG algorithms such as linear congruential generators, Lagged Fibonacci generators, linear feedback shift registers, generalized feedback shift registers, the Blum Blum Shub algorithm, one of the Fortuna family of algorithms, the Mersenne twister algorithm, a Monte Carlo method, etc.

Some implementations may involve a combination of non-random and random or pseudorandom processes. For example, in some implementations, some angle and/or area attributes may be applied according to a pattern to which a certain amount of “noise” has been applied, e.g., according to a dithering algorithm, a color halftoning method, etc.

In step 1040, the selected area of the holographic medium is illuminated by the object beam and the reference beam. The object beam illumination angle is set to the value determined in step 1035. If the reference beam illumination angle also varies, the reference beam illumination angle may also be set to a value determined in step 1035.

In step 1045, it is determined whether all areas of the holographic medium have been illuminated. If so, the process ends. (Step 1049.) If not, another area is selected for illumination. (Step 1030.) In some implementations, each area may be illuminated more than once. If so, step 1045 may comprise a determination of whether all areas have been illuminated a predetermined number of times.

Some implementations may involve purely mathematical determinations of, e.g., which illumination angles to use, how many to use, how to vary the illumination angles, how to vary area attributes, etc. However, other implementations may involve an iterative process to determine one or more of these parameters. The iterative process may involve, for example, using mathematical methods (which may involve the mathematics underlying the optics involved, Monte Carlo or other simulations, etc.) to determine a tentative solution, applying the mathematical methods to form a hologram and evaluating the actual performance of the hologram. The evaluation may involve machine and/or human inspection, and may involve a determination of whether there is still a detectable “rainbow” effect, whether a particular color is noticeably prominent in one or more areas of a display, and/or other factors. The results of the inspection may be used to adjust the parameters used to make another hologram. This process may be continued until a hologram having acceptable properties has been made. The parameters used for the acceptable hologram may be applied for mass production.

FIG. 10B illustrates one embodiment of a system that may be used to prepare a hologram according to some implementations described herein, e.g., according to a process such as that of method 1000. In this example, hologram fabrication system 1050 includes reference beam system 1051 and object beam system 1061. In some such embodiments, the components of reference beam system 1051 and object beam system 1061, as well as other components of system 1050, operate under the control of a logic system such as that described below with reference to FIG. 10D.

Reference beam system 1051 includes reference laser assembly 1053, which is configured to provide a suitable reference beam 605. Reference laser assembly 1053 may include a laser and suitable optics, such as filters and/or lenses, examples of which will be described below with reference to object laser assembly 1063. Reference beam system 1051 may also include devices for the accurate positioning of reference laser assembly 1053. In this example, these devices include translation stage 1055a, goniometer 1057a and rotation stage 1059a. Translation stage 1055a is configured to move laser assembly 1053 along axis 1056, goniometer 1057a is configured to position laser assembly 1053 at a desired tilt angle around axis 1056 and rotation stage 1059a is configured to position laser assembly 1053 at a desired angle around axis 1058.

In some such embodiments, a control system, such as logic system 1080 depicted in FIG. 10D, automatically controls reference laser assembly 1051 to position reference beam 605 on the proper area 705 of holographic medium 615. Although reference beam 605 impinges on a top side of holographic medium 615 in the example shown in FIG. 10B, in alternative embodiments reference laser assembly 1051 may be configured to direct reference beam 605 to the opposing side of holographic medium 615. Holographic medium 615 may be supported by a stage or the like (not shown), which in some embodiments may also be translated or rotated, e.g., according to commands from a control system.

Object beam system 1061 includes object laser assembly 1063, which is configured to provide a suitable object beam 710. In this example, object laser assembly 1063 includes laser 1065 and optical assembly 1067, which may include filters and/or lenses. For example, optical assembly 1067 may include a collimating lens configured to broaden the laser beam emitted from laser 1065. Optical assembly 1067 may also include one or more filters, e.g., a spatial filter for shaping object beam 710. Some examples are described below with reference to FIG. 10C.

Object beam system 1061 may also include devices for the accurate positioning of object laser assembly 1063. In this example, these devices include translation stages 1055b and 1055c. Translation stage 1055b is configured to move laser 1065 up or down, whereas translation stage 1055c is configured to move laser 1065 laterally.

In addition to mirror 1071, mirror assembly 1070 includes translation stages 1055d and 1055e for moving mirror 1071 laterally, as well as goniometers 1057b and 1057c for rotating mirror 1071 to desired positions around axes 1072 and 1074, respectively. In some such embodiments, a control system, such as logic system 1080 depicted in FIG. 10D, automatically controls object laser assembly 1063 and mirror assembly 1070 to position object beam 710 on the proper area 705 of holographic medium 615.

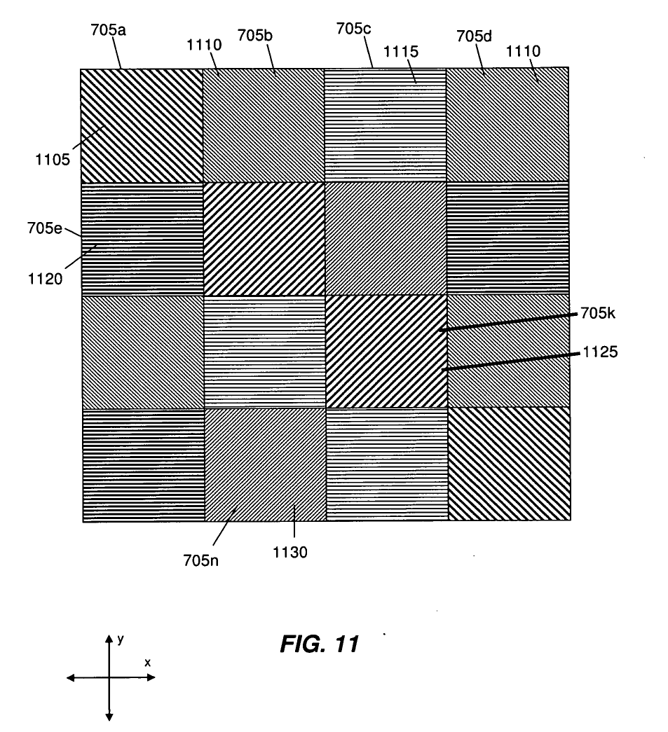

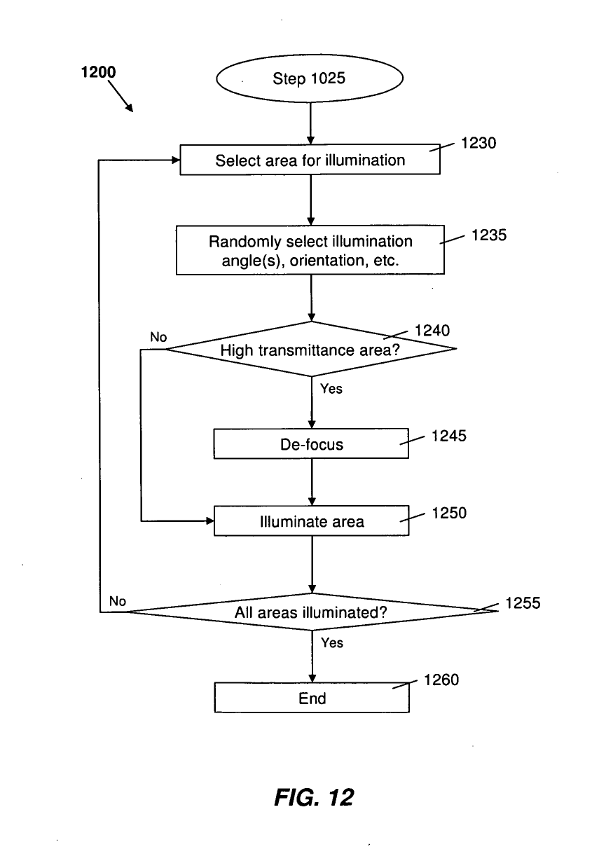

The hologram fabrication system 1050 depicted in FIG. 10B, is merely illustrative; many other variations and permutations are contemplated by the inventor. For example, hologram fabrication system 1050 may include more or fewer features than those are not shown in FIG. 10B. Such features may include, but are not limited to, lenses, masks, filters, etc. For example, some implementations may include a neutral density filter in the path of object beam 710 and/or reference beam 605. Spatial filters may be used to control the size and/or shape of object beam 710 and/or reference beam 605. A coherence modifying filter, such as a phase change filter or a speckled filter, may be used to alter the coherence of object beam 710 and/or reference beam 605. Such elements may be introduced into the beam path at a variety of locations in order to obtain desired effects, e.g., such as those described below with reference to FIGS. 11 and 12.

Some such additional features are illustrated in FIG. 10C. In this example, optical assembly 1067 of object laser assembly 1063 includes collimator optics for expanding the beam from laser 1065. Optical assembly 1067 also includes spatial filter 1069 for shaping object beam 710. Spatial filters, including but not limited to spatial filter 1069, may be used to control the shape and/or size of the areas 705 on which individual diffraction patters will be formed. For example, if one desires to expose a rectangular area, spatial filters may be used to produce a beam that is substantially rectangular in cross-section.

One such example is shown in FIG. 10C. Here, a laser beam with a small cross-sectional area is emitted by laser 1065. Collimator 1067 expands the beam to a desired cross-sectional dimension, e.g., half an inch in diameter, an inch in diameter, two inches in diameter, or whatever may be considered appropriate for the particular implementation. The collimated beam then passes through aperture 1069 of spatial filter 1068, which produces a substantially rectangular object beam 710a. Here, translation stages 1055k and 1055l are configured to control the orientation of spatial filter 1068 and therefore of aperture 1069.

Causing the beam to pass through spatial filter 1068 may cause diffraction. Therefore, in this example object beam 710a is passed through another spatial filter 1075, which includes another rectangular aperture 1079 to mask out the resulting diffraction orders. It is desirable to select the size of aperture 1079 to minimize or eliminate the additional diffraction that would otherwise be caused when object beam 710a passes through aperture 1079. For example, the size of aperture 1079 may be made large enough to allow object beam 710a to pass through aperture 1079 without being diffracted, although small enough to only pass the 0^{th} diffraction order produced by spatial filter 1069. In this example, translation stages 1055f and 1055g may control the orientation of spatial filter 1075 and therefore of aperture 1079.

In this example, object beam system 1061 includes filter 1077, the position of which may be controlled by translation stages 1055h and 1055i. Filter 1077 may, for example, comprise a neutral density filter or a coherence modifying filter, such as a phase change filter or a speckled filter, which may be used to alter the coherence of object beam 710. In some such implementations, translation stage 1055h, translation stage 1055i, a goniometer, a rotation stage, or another such device may be used to selectively introduce or remove filter 1077 from the path of object beam 710 or reference beam 605. Such implementations may be used to produce relatively lower efficiency light extraction areas or relatively higher efficiency light extraction areas in holographic medium 615, e.g., as described below with reference to FIG. 12.

FIG. 10D is a block diagram that depicts various components of a hologram fabrication system 1050 according to some embodiments. Reference beam system and object beam system may be substantially as described elsewhere herein or they may have more or fewer components, different layouts, etc. Logic system 1080 comprises one or more logic devices, which may be processors, programmable logic devices, etc. Some methods of the invention may be implemented, at least in part, by one or more computer programs embodied in machine-readable media and executed by logic system 1080. The computer program(s) may, for example, include instructions for exposing each of a plurality of areas of holographic recording material with object beams and/or reference beams having orientations that vary randomly or pseudorandomly.

In some embodiments, logic devices of logic system 1080 may have specialized functions, such as controlling one or more devices of reference beam system 1051, controlling one or more devices of object beam system 1061, auxiliary optics 1082 that are not shown herein, interface system 1084, etc. In some implementations, logic system 1080 may comprise logic devices of a single apparatus, whereas in other implementations logic system 1080 may comprise logic devices of more than one apparatus.

Interface system 1084 may comprise one or more user interfaces, such as keyboards, touch screens, mice, joy sticks, thumb pads, etc. Moreover, interface system 1084 may comprise network interfaces that are configured, e.g., for communication between logic system 1080 and other devices via a local area network, a wide area network, etc. Interface system 1084 may comprise wired and/or wireless interfaces for communication via Bluetooth, via one or more of the Institute for Electrical and Electronics Engineers (“IEEE”) 802.11 protocols, via one or more of the Infrared Data Association (“IrDA”) protocols, etc. For example, logic system may control components of reference beam system 1051, object beam system 1061, auxiliary optics 1082, etc., via communications through such wired or wireless interfaces.

FIG. 11 illustrates diffraction gratings that have been formed in areas 705 of a holographic medium according to some implementations provided herein. In this example, there is a variation of both the diffraction grating orientations and diffraction grating spacing from one area to the next. These orientations will be described with reference to the x and y axes depicted in FIG. 11.

In this example, there are 6 types of diffraction grating. Type 1105, which is formed in area 705a, has the same orientation as that of type 1110 (see area 705b). However, type 1105 has a relatively wider diffraction grating spacing than that of type 1110. Similarly, types 1125 (see area 705k) and 1130 (see area 705n) have the same orientation. However, type 1125 has a relatively wider diffraction grating spacing than that of type 1130.

Type 1115 (see area 705c) has a different orientation from that of type 1105 and type 1110: in this example, type 1115 has a diffraction grating that is depicted as parallel to the x axis, whereas the diffraction gratings depicted for types 1105 and 1110 have a slope of −1. Moreover, type 1115 has a different diffraction grating spacing than that of either type 1105 or type 1110. Type 1120 has the same orientation as type 1115, but is depicted as being more sharply focused. Accordingly, type 1120 may extract light more efficiently than type 1115.

Some implementations provided herein exploit such variations in light extraction efficiency. In order to provide a more uniform illumination of a display, for example, some parts of a hologram used to extract light from a waveguide may be made relatively more or relatively less efficient at extracting light. For example, areas that are relatively less efficient at extracting light (also referred to herein as low efficiency light extraction areas) may be formed in parts of the hologram that will be disposed relatively closer to a light source, thereby allowing additional light to be available farther from the light source. In some implementations, the low efficiency light extraction areas may comprise unfocused diffraction gratings that are formed in the holographic recording material.

One related method 1220 will now be described with reference to FIG. 12. Here, part of a process similar to that of method 1000, described above with reference to FIG. 10A, may have already taken place. Attributes of an object beam and/or a reference beam may already have been selected. For example, steps up to step 1015 or 1025 of method 1000 may already have been performed.

In step 1230, an area is selected for illumination. In step 1235, a random or pseudorandom selection may be made from among previously-determined attributes of an object beam and/or a reference beam. For example, the illumination angle, orientation, etc., of an object beam and/or a reference beam may be randomly or pseudorandomly selected from a predetermined number of options.

In step 1240, it is determined whether the area to be illuminated will be a low efficiency light extraction area. This determination may be made, for example, by referring to a data structure of areas 705 and corresponding desired properties of these areas. In some implementations, if the area to be illuminated is determined to be a low efficiency light extraction area, a filter such as filter 1077 of FIG. 10C may be introduced into the object beam path and/or the reference beam path. (Step 1245.) As noted above, the filter may comprise a neutral density filter, a phase change filter or a coherence modifying filter such as a speckled filter. Alternatively, or additionally, the light source intensity and/or exposure time may be reduced to form relatively low efficiency light extraction areas.

In some implementations, relatively low efficiency light extraction areas may be formed, at least in part, by reducing the size of exposed areas 705. For example, the size of aperture 1079 and/or 1069 may be reduced in order to expose a smaller sized area 705. In some such implementations, the resulting hologram may include unexposed areas in between areas 705. Although the areas 705 are depicted in FIG. 11 as being substantially contiguous “tiles” or the like, with some such implementations, there may be spaces in between the “tiles.” Accordingly, such implementations involve forming at least some non-continuous areas 705 in holographic medium 615. In some such implementations, other factors (such as light intensity, exposure time, beam coherence, etc.) may also be altered to further reduce the light extraction efficiency of such areas.

When such areas are illuminated (step 1250), an area of the hologram that is relatively less efficient at extracting light from a waveguide will be formed. The process may continue until it is determined in step 1255 that all areas to be illuminated have been illuminated a predetermined number of times. Then, the process ends.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

We claim:

1. A method of forming a hologram, comprising:
directing at least one reference beam to a holographic recording material; and
illuminating 1^{st} through M^{th} areas of the holographic recording material with object beams at 1^{st} through N^{th} illumination angles relative to a normal to the surface of the holographic recording material, wherein the illuminating comprises forming a random or pseudorandom distribution of the 1^{st} through N^{th} illumination angles across the 1^{st} through M^{th} areas of the holographic recording material.

2. The method of claim 1, further comprising determining low efficiency light extraction areas of the holographic recording material, wherein the illuminating comprises forming unfocused diffraction gratings in the low efficiency light extraction areas of the holographic recording material.

3. The method of claim 1, wherein the illuminating further comprises forming a random or pseudorandom distribution of diffraction grating spacing across the 1^{st} through M^{th} areas of the holographic recording material.

4. The method of claim 1, wherein the illuminating further comprises forming a random or pseudorandom distribution of diffraction grating angles across the 1^{st} through M^{th} areas of the holographic recording material, the diffraction grating angles measured from a first axis parallel to a first diffraction grating of a first area to a second axis parallel to a second diffraction grating of an adjacent area.

5. The method of claim 1, wherein the 1^{st} through M^{th} areas are contiguous areas of the holographic recording material.

6. The method of claim 1, wherein the 1^{st} through M^{th} areas are non-contiguous areas of the holographic recording material.

7. The method of claim 1, wherein the 1^{st} through M^{th} areas are overlapping areas of the holographic recording material.

8. The method of claim 1, wherein the 1^{st} through N^{th} illumination angles are within a range of minus six to six degrees relative to the normal.

9. The method of claim 1, wherein the 1^{st} through N^{th} illumination angles are within a range of minus twelve to twelve degrees relative to the normal.

10. The method of claim 1, wherein the 1^{st} through N^{th} illumination angles are within a range of minus 25 to 25 degrees relative to the normal.

11. The method of claim 1, wherein the directing comprises directing a plurality of reference beams to the holographic recording material.

12. The method of claim 10, wherein each of the plurality of reference beams is directed within a range of 55 to 75 degrees relative to the normal.

13. A method of manufacturing an illumination device, the method comprising:
forming a substantially planar light guide having a light coupling section and an adjacent light turning section, the light coupling section configured to receive light from a light source and propagate the light through the light guide to the light turning section, the light turning section being configured to direct light from the light coupling section out of the light guide,
wherein forming the light turning section comprises the following:
directing at least one reference beam to a holographic recording material; and
illuminating 1^{st} through M^{th} areas of the holographic recording material with object beams at 1^{st} through N^{th} illumination angles relative to a normal to the surface of the holographic recording material, wherein the illuminating comprises forming a random or pseudorandom distribution of the 1^{st} through N^{th} illumination angles across the 1^{st} through M^{th} areas of the holographic recording material.

14. The method of claim 13, wherein the light coupling section is configured to receive light through a front surface or a back surface of the light guide.

15. The method of claim 13, wherein the light coupling section is configured to receive light through a side surface of the light guide.

16. The method of claim 13, wherein the illuminating comprises forming low efficiency light extraction areas of the holographic recording material.

17. The method of claim 13, wherein the illuminating further comprises forming a random or pseudorandom distribution of diffraction grating spacing across the 1^{st} through M^{th} areas of the holographic recording material.

18. The method of claim 13, wherein the illuminating further comprises forming a random or pseudorandom distribution of diffraction grating angles across the 1^{st} through M^{th} areas of the holographic recording material, the diffraction grating angles measured from a first axis parallel to a first diffraction grating of a first area to a second axis parallel to a second diffraction grating of an adjacent area.

19. The method of claim 13, wherein the 1^{st} through M^{th} areas are contiguous areas of the holographic recording material.

20. The method of claim 13, wherein the 1^{st} through M^{th} areas are overlapping areas of the holographic recording material.

21. The method of claim 13, wherein the 1^{st} through M^{th} areas are non-contiguous areas of the holographic recording material.

22. An apparatus, comprising:
a light guide;
at least one light source configured to provide light to the light guide;
a display disposed substantially parallel to the light guide; and
a hologram configured to extract light from the light guide and provide light to the display, the hologram comprising a plurality of areas, each area having a diffraction grating configured to provide light to the display at a predetermined angle, the predetermined angle being randomly or pseudorandomly distributed over the plurality of areas.

23. The apparatus of claim 22, wherein the diffraction grating of each area has an angular orientation with respect to the diffraction grating of an adjacent area, the angular orientations being randomly or pseudorandomly distributed over the plurality of areas.

24. The apparatus of claim 22, wherein the diffraction gratings in selected areas are not in focus.

25. The apparatus of claim 22, wherein the diffraction gratings in selected areas of the hologram are formed to be less efficient at light extraction than the diffraction gratings in other areas of the hologram.

26. The apparatus of claim 22, wherein the display comprises a plurality of reflective interferometric modulators.

27. The apparatus of claim 22, wherein the hologram is a reflective hologram.

28. The apparatus of claim 22, wherein the hologram is a transmissive hologram.

29. The apparatus of claim 22, wherein the hologram comprises volume phase holographic diffraction gratings.

30. The apparatus of claim 22, further comprising:
a processor that is configured to communicate with the display, the processor being configured to process image data; and
a memory device that is configured to communicate with the processor.

31. The apparatus of claim 25, wherein the selected areas of the hologram are proximate at least one light source.

32. The apparatus of claim 25, wherein the selected areas are selected to provide substantially uniform illumination of the display.

33. The apparatus of claim 30, further comprising a driver circuit configured to send at least one signal to the display.

34. The apparatus of claim 30, further comprising an image source module configured to send the image data to the processor.

35. The apparatus of claim 33, further comprising a controller configured to send at least a portion of the image data to the driver circuit.

36. The apparatus as recited in claim 34, wherein the image source module comprises at least one of a receiver, a transceiver or a transmitter.

37. An apparatus, comprising:
means for guiding light;
light source means configured to provide light to the light guiding means;
display means disposed substantially parallel to the light guiding means;
means for extracting light from the light guide and providing light to the display, the light extracting means comprising a plurality of areas, each area having a diffraction grating configured to provide light to the display at a predetermined angle, the predetermined angle being randomly or pseudorandomly distributed over the plurality of areas.

38. The apparatus of claim 37, wherein the diffraction grating of each area has an angular orientation with respect to the diffraction grating of an adjacent area, the angular orientations being random or pseudorandomly distributed over the plurality of areas.

39. The apparatus of claim 37, wherein the diffraction gratings in selected areas of the light extracting means are formed to be less efficient at light extraction than the diffraction gratings in other areas of the light extracting means.

40. The apparatus of claim 37, wherein the display means comprises a plurality of reflective interferometric modulators.

41. The apparatus of claim 37, wherein the light extracting means comprises at least one of a reflective hologram, a transmissive hologram or a volume phase hologram.

42. The apparatus of claim 37, further comprising a logic system that is configured to communicate with the display means, the logic system being configured to process image data.

43. The apparatus of claim 42, further comprising an image source module configured to send the image data to the logic system.
